(19) United States
(12) Patent Application Publication
(10) Pub. No.: US 2026/0163870 A1
(43) Pub. Date: Jun. 11, 2026

(54) Method for securing an aircraft video link from a first domain to a second domain, implemented with controlled spatial and temporal parameterization, associated system and aircraft

(71) Applicant: DASSAULT AVIATION, Paris (FR)

(72) Inventor: Darius ASHTARI, Saint-Cloud Cedex (FR)

(21) Appl. No.: 19/413,721

(22) Filed: Dec. 9, 2025

(30) Foreign Application Priority Data
Dec. 10, 2024 (FR) FR2413740
Dec. 10, 2024 (FR) FR2413746

(51) Int. Cl. H04L 9/40; B64D 11/00; H04N 7/18

(52) U.S. Cl. CPC H04L 63/0428; B64D 11/0015; H04N 7/18

(57) ABSTRACT

A method for securing an aircraft video link from a first domain to a second domain, implemented with controlled spatial and temporal parameterization, associated system and aircraft, the method including receiving, from a first domain, an input video data stream according to an input control plane including spatial and temporal parameterization of the input video data stream, transmitting to the second domain an output video stream obtained from the input video data stream, according to an output control plane including spatial and temporal parameterization, and provision, by the security system, of input control plane parameters imposed on the first domain, the imposed input control plane parameters including spatial and temporal input parameterization defined by the security system.

The present disclosure relates to a method for securing an aircraft video link from a first domain with lower security requirements to a second domain with higher security requirements, and including the following steps:
receiving, from the first domain, an input video data stream according to an input control plane including spatial and temporal parameterization of the input video data stream;
transmitting to the second domain an output video stream obtained from the input video data stream, according to an output control plane including spatial and temporal parameterization.

The method being implemented by a security system.

### BACKGROUND

Such a method is intended to be implemented in an aircraft, for example in a cockpit of the aircraft, to ensure a video link from a system generating a video stream in an open domain, such as an operator service domain or a passenger service domain, to a more secure domain, such as an aircraft control domain including an avionics unit of the aircraft.

The security of the aircraft control domain is essential to prevent takeover or malicious attacks against vital aircraft functions, such as flight controls.

In this regard, the aircraft control domain is segregated from other more open domains of the aircraft.

However, the transmission of video streams from certain computer systems in the operator service domain or the passenger service domain, such as an Electronic Flight Bag (EFB) or a Modular Maintenance System (MMS), may be desired. This would allow, in particular, the display of these video streams on avionics screens in the cockpit and would allow the crew to remotely access the displays of these systems.

Such video stream transmission is currently generally avoided, although some systems like the one described in US2020/0326205 consider it. However, this transmission opens up cybersecurity risks.

Thus, video transmission protocols are susceptible to attack by malicious third parties, particularly to impact the integrity of avionics or other critical aircraft systems, or more simply, to temporarily or permanently disrupt the availability of avionics or other aircraft systems.

This can be done, for example, by sending malformed data (notably in terms of message size, illegal characters) using legitimate commands within, for example, an unsupervised control channel. Other malicious actions would consist of attempting to encapsulate malicious messages from an uncontrolled protocol into a regular protocol and/or sending aberrant control plane parameters to systems in the critical domain.

### SUMMARY

An aim of the present disclosure is to obtain a method allowing cybersecurity ensuring the control of an aircraft video stream transmitted from a domain with lower security requirements to a domain with higher security requirements, notably to the aircraft control domain.

To this end, the present disclosure relates to a method of the aforementioned type, characterized by the following step:
provision, by the security system, of input control plane parameters imposed on the first domain, the imposed input control plane parameters including spatial and temporal input parameterization defined by the security system.

The method according to the present disclosure may comprise one or more of the following features, taken alone or in any technically possible combination:
the spatial and temporal input parameterization defined by the security system includes predetermined values of spatial and temporal parameters of the input video data stream;
the predetermined values are stored in a memory of the security system, particularly in a read-only memory of the security system;
the spatial and temporal input parameterization includes a frame definition, synchronization including a clock frequency and image refresh rate and/or a resolution of the input video data stream;
it comprises, before the transmission of the output video stream to the second domain, a step of testing the conformity of the spatial and temporal parameterization of the input video data stream received from the first domain with respect to the defined spatial and temporal input parameterization provided to the first domain by the security system;
the verification step comprises, in the case of non-conformity of the spatial and temporal parameterization of the input video data stream received from the first domain with respect to the defined spatial and temporal input parameterization provided to the first domain, the generation of an alert in an alert log, the verification step optionally comprising the deletion of the input video data stream after generating the alert and/or after storing the alert in the storage log, without transmission of the input video data stream to the second domain;
it comprises a step of controlling the conformity of the output video stream with respect to the second video transmission protocol, before transmission to the second domain, the conformity control step optionally comprising, in the case of non-conformity of the output video stream, the generation of a security alert and/or the storage of the alert in an alert log, the verification step optionally comprising the deletion of the output video stream in the case of non-conformity of the output video stream after generating the alert and/or storing the alert in the alert log;
the transmission to the second domain of the output video stream is carried out according to an ARINC 818 protocol, a Digital Video Interface (DVI) protocol, a Display Port (DP) protocol, a high-definition multimedia interface (HDMI) protocol, or a serial digital interface (SDI) protocol, notably 3G-SDI;
the provision to the first domain of the spatial and temporal input parameterization is carried out via an input control plane parameter stream using a dedicated transmission channel, distinct from a transmission channel of the input video data stream, preferably according to a Display Data Channel (DDC) protocol and/or according to an Inter-Integrated Circuit (I2C) protocol;
the second domain is an aircraft control domain including at least one avionics unit;
the first domain is a passenger service domain of the aircraft configured to include at least one passenger service system, and/or is an operator service domain of the aircraft configured to include at least one operator service system;
the input video data stream is received using a first video transmission protocol encapsulating image data and complementary data, the method comprising the following steps:
   decapsulation of the input video data stream to extract image data and filtering of at least a portion of the complementary data,
   re-encapsulation of the image data using a second video transmission protocol to generate an output video stream,
   transmission to the second domain of the output video stream using the second transmission protocol;
the first video transmission protocol is different from the second video transmission protocol;
the first video transmission protocol is identical to the second video transmission protocol;
it comprises a step of adding, to the output video stream before its transmission to the second domain, a compliance indicator of the spatial and temporal parameterization of the output video stream in reference to a defined spatial and temporal output parameterization;
the compliance indicator includes a cyclic redundancy check corresponding to the defined spatial and temporal output parameterization.

The present disclosure also relates to a security system for an aircraft video link from a first domain with lower security requirements to a second domain with higher security requirements, the security system including:
a receiving module, from the first domain, of an input video data stream according to an input control plane including spatial and temporal parameterization of the input video data stream;
a transmission module to the second domain of an output video stream obtained from the input video data stream, according to an output control plane including spatial and temporal parameterization, characterized by a module for providing input control plane parameters imposed on the first domain, the imposed input control plane parameters including spatial and temporal input parameterization defined by the security system.

The system according to the present disclosure may comprise a programmable logic component or a dedicated logic circuit carrying out the receiving module, the transmission module, and the module for providing imposed input control plane data, the security system preferably including a memory storing predetermined values of spatial and temporal input parameters of the input video data stream.

The present disclosure also relates to an aircraft comprising:
a first domain with lower security requirements comprising at least one system for generating an input video data stream according to an input control plane including spatial and temporal parameterization of the input video data stream,
a security system as defined above, configured to generate an output video stream according to an output control plane including spatial and temporal parameterization, from the input video data stream,
a second domain with higher security requirements comprising at least one system for processing and/or displaying the output video stream connected to the security system.

The aircraft according to the present disclosure may comprise one or more of the following features, taken alone or in any technically possible combination:
the video stream security system forms a video interface between the first domain and the second domain, the security system being configured to receive the input video stream according to the first video transmission protocol and to generate the output video stream from the input video stream, according to the second video transmission protocol;
the first video transmission protocol is different from the second video transmission protocol or the first video transmission protocol is identical to the second video transmission protocol;
the security system comprises a programmable logic component or a dedicated logic circuit configured to receive the input video stream according to the first video transmission protocol and to generate the output video stream from the input video stream, according to the second video transmission protocol;
the security system includes at least one input for receiving the input video stream, configured to receive the input video stream from the input video stream generation system;
the or each input for receiving the input video stream is configured to receive a video stream according to a Digital Video Interface protocol, a Display Port protocol, a high-definition multimedia interface (HDMI) protocol, or a serial digital interface (SDI) protocol, notably 3G-SDI;
the or each input for receiving the input video stream forms a first transmission channel of an input video data stream from the first domain, the security system including at least one input/output of control plane parameters forming a second transmission channel of control plane parameters to the first domain;
the security system comprises a memory containing predetermined values of a spatial and temporal input parameterization of the control plane, the memory being connected to the or each input/output of control plane parameters to allow the transmission of predetermined values of the spatial and temporal input parameterization of the control plane to the first domain through the second transmission channel;
the security system comprises at least one output for transmitting the output video stream connected to the second domain;
the output for transmitting the output video stream is configured to emit an output video stream according to an ARINC 818 protocol, a Digital Video Interface (DVI) protocol, a Display Port (DP) protocol, a high-definition multimedia interface (HDMI) protocol, or a serial digital interface (SDI) protocol, notably 3G-SDI;
the security system comprises a module for de-encapsulating an input video data stream received according to the first video transmission protocol to extract image data and a module for re-encapsulating image data according to a second video transmission protocol to generate the output video stream;
the second domain is an aircraft control domain including at least one avionics unit;
the first domain is a passenger service domain of the aircraft configured to include at least one passenger service system, and/or is an operator service domain of the aircraft configured to include at least one operator service system;
the processing and/or display system of an output video stream comprises at least one display area of the output video stream or a video stream produced using the output video stream;
it comprises a selection and/or control system configured to allow user interaction on the display area, the aircraft including a unidirectional return link from the selection and/or control system to the first domain without passing through the security system;
the unidirectional return link operates according to a User Datagram Protocol, an RS232 protocol, an RS422 protocol, an ARINC 429 protocol, or an ARINC 729 protocol.

### BRIEF DESCRIPTION OF THE DRAWINGS

The present disclosure will be better understood by reading the following description, given solely by way of example and referring to the appended drawings, wherein:

FIG. 1 is a schematic view of an aircraft according to the present disclosure comprising several domains with lower security requirements and a domain with higher security requirements, a stream security system according to the present disclosure being interposed between the domains with lower security requirements and the domain with higher security requirements.

FIG. 2 is a security flowchart illustrating the implementation of a first security method according to the present disclosure.

FIG. 3 is a flowchart illustrating the implementation of a second security method according to the present disclosure.

### DETAILED DESCRIPTION

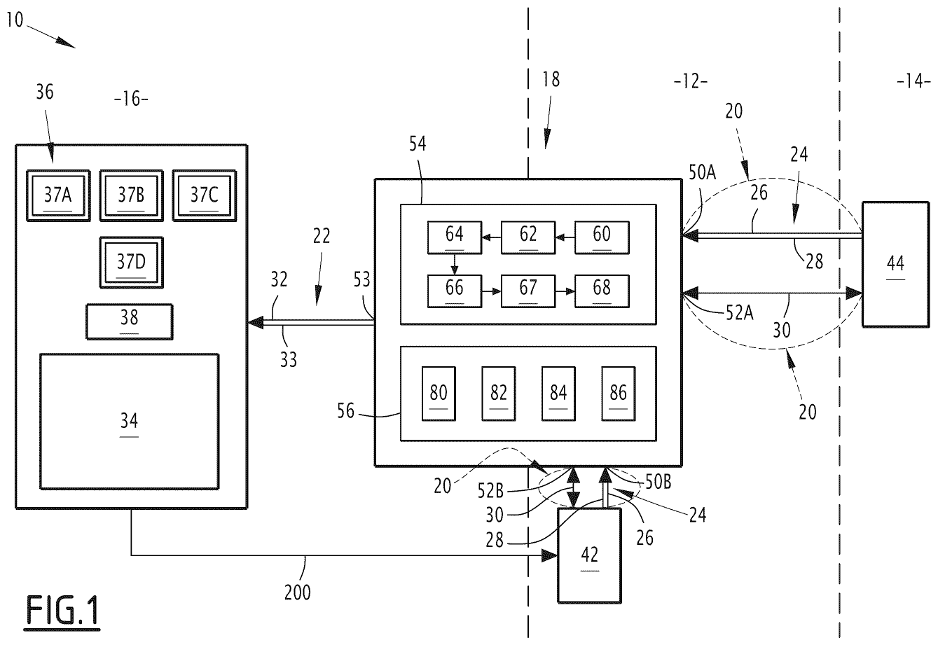

The relevant parts of a first aircraft 10 according to the present disclosure are schematically illustrated in FIG. 1.

The aircraft 10 thus comprises an onboard computer infrastructure including at least one first computer domain 12, 14 with lower security requirements, the first domain 12, 14 comprising at least one system capable of generating and/or transmitting at least one video stream.

The computer infrastructure comprises at least one second computer domain 16 with higher security requirements, comprising at least one system capable of receiving the or each video stream, to process and/or display it.

The aircraft 10 further comprises, according to the present disclosure, a video link security system 18 between the or each first domain 12, 14 and the second domain 16, to allow the second domain to securely receive the video stream generated by the first domain 12, 14.

The video stream comprises an input video stream 20 generated in the first domain 12, 14 and transmitted to the security system 18 and an output video stream 22 generated by the security system 18 from the input video stream 20.

The input video stream 20 is generated according to a first video transmission protocol, for example, a Digital Video Interface (DVI) protocol, a Display Port (DP) protocol, a high-definition multimedia interface (HDMI) protocol, or a serial digital interface (SDI) protocol, notably 3G-SDI.

It includes, according to a first transmission channel, an input video data stream 24 comprising successive image data 26 configured to be projected in succession and complementary data 28.

The input video stream 20 further comprises in this example, according to a second transmission channel, a bidirectional input control plane parameter stream 30 exchanged between the security system 18 and the or each first domain 12, 14 to control the spatial and temporal input parameterization of the input video data stream 24.

The spatial and temporal input parameterization of successive image data contained in the input video data stream 24 includes, for example, at least a frame definition, synchronization, including a clock frequency and image refresh rate, and a predefined resolution for successive images, which are transmitted to the first domain 12, 14 by the security system 18 in the input control plane parameter stream 30.

The complementary data 28 present in the input video data stream 24 include metadata associated with frames and/or images including, for example, a date, an order, a source identifier, enrichment data, such as subtitles, and/or control plane data, notably a cyclic redundancy check allowing verification that the frames, synchronization, and resolution of image data correspond to those defined by the security system 18. In some video protocols, the complementary data 28 also comprise network or bus routing information, such as recipient addresses of the video stream, for example.

The output video stream 22 is generated by the security system 18 according to a second video transmission protocol, according to an output control plane with a predefined spatial and temporal output parameterization. The second video transmission protocol is, for example, an ARINC 818 protocol, a Digital Video Interface (DVI) protocol, a Display Port (DP) protocol, a high-definition multimedia interface (HDMI) protocol, or a serial digital interface (SDI) protocol, notably 3G-SDI.

The output video stream 22 notably comprises output image data 32 from the input video data stream 24 and verification data 33 of compliance with the predefined output control plane, for example in the form of a cyclic redundancy check established from the frame definition, synchronization, and resolution used to generate the output image data 32.

In the example shown in FIG. 1, the aircraft 10 comprises several first domains 12, 14 with lower security requirements, notably an operator service domain 12 and a passenger service domain 14.

Each first domain 12, 14 includes at least one system 42, 44, in particular at least one computer, configured to be permanently or disconnectably connected to the security system 18. The or each system 42, 44 is configured to generate the input video stream 20 intended to be received by the security system 18.

The or each system 42, 44 is, for example, an onboard computer, a disconnectable computer from the aircraft 10, or a portable terminal, such as a laptop, tablet, or mobile phone.

The operator service domain 12 relates notably to the maintenance of the aircraft and the support of the crew in their work during the different phases of the mission. This includes notably access to various technical and aeronautical documentation resources available onboard, or on removable equipment.

The system 42 generating the input video stream is, for example, an Electronic Flight Bag (EFB) or a Modular Maintenance System (MMS).

The passenger service domain 14 includes, for example, the control of material resources specific to passenger comfort, passenger entertainment, interactive mobile maps, functions dedicated to the cabin crew, and interface resources with the terminals and devices specific to the aircraft occupants.

The system 44 generating the input video stream 20 is, for example, a video camera system intended to film the interior or exterior of the aircraft (for example, a tail camera) or an internet navigation software hosted on a computer, notably of low trust in terms of cybersecurity.

The aircraft control domain 16 notably includes engine control applications, flight controls, and aircraft systems control. It comprises at least one central avionics unit 34 and at least one display device 36.

The central avionics unit 34 comprises at least one computer and a memory configured to receive data from the different aircraft systems and to process them, to possibly control aircraft systems and execute flight commands.

The display device 36 comprises at least one display area, for example, located in the cockpit of the aircraft 10.

In the example shown in FIG. 1, the display device 36 includes at least one dedicated display area 37A, intended to be placed in front of a first crew member, in front of a first cockpit seat, at least one dedicated display area 37B, intended to be placed in front of a second crew member, in front of a second cockpit seat, and at least one display area visible to both crew members 37C, 37D placed between the first display area 37A and the second display area 37B.

The display device 36 optionally includes a first dedicated head-up display area, intended to be placed in front of the first seat, and a second dedicated head-up display area, intended to be placed in front of the second seat.

The display device 36 further includes a display management set 38 dedicated to controlling the display on the different display areas 37A to 37D, notably offering the display of the output video stream 22 received from the security system 18 or a video stream produced using the output video stream 22. The display management set 38 comprises physical and/or software components configured to generate and control the display.

The first dedicated display area 37A and the second dedicated display area 37B are generally defined by primary display screens, located in front of the seat of each respective crew member. They are intended to display, for example, at least one flight parameter window.

The upper display area 37C visible to both crew members and the lower display area 37D visible to both crew members are respectively defined on a multifunctional navigation screen intended to display at least one navigation window and on a control and/or monitoring screen of the aircraft systems to display at least one aircraft system monitoring and/or control window.

Alternatively, the display areas 37A to 37D are located on a common screen, for example, in a T-shape.

In the example shown in FIG. 1, the display device 36 is further configured to process and/or display the successive images contained in the output video stream 22, for example, on a display area 37A to 37D, notably on areas 37B and 37D.

The security system 18 is placed at an interface between the or each first domain 12, 14 and the second domain 16.

In this example, the security system 18 is formed of at least one calculator, which is an electronic circuit designed to manipulate and/or transform data represented by electronic or physical quantities in the registers and/or memories of the calculator into other similar data corresponding to physical data in the registers or other types of display, transmission, or storage devices.

Preferably, the security system 18 is realized in the form of a programmable logic component, such as an FPGA (Field Programmable Gate Array), or a dedicated integrated circuit, such as an ASIC (Application Specific Integrated Circuit). These components define functional modules of the security system 18.

Alternatively, the security system 18 is realized in the form of at least one processor and at least one memory containing software modules configured to be executed by the processor.

Referring to FIG. 1, the security system 18 includes at least one input 50A, 50B for receiving the input video data stream 24, at least one input/output 52A, 52B for transmitting/receiving the input control plane parameter stream 30.

The security system 18 also includes at least one output 53 for transmitting the output video stream 22.

It comprises a processing unit 54 of the input video stream 20 configured to generate the output video stream 22 and a control unit 56 of the input control plane of the input video stream 20.

In the example shown in FIG. 1, the security system 18 comprises at least one input 50A configured to be directly connected to a system 44 of the passenger service domain 14 and at least one input 50B connected to a system 42 of an operator service domain 12.

Each input 50A, 50B is configured to receive the input video data stream 24 according to the input transmission protocol while complying with the input control plane parameters transmitted to the system 42, 44 via the input/output 52A, 52B.

The processing unit 54 of the input video stream 20 is connected to the or each input 50A and 50B. It includes a receiving and compliance test module 60 of the input video data stream 24, a de-encapsulation module 62 of the input video data stream 24 to extract image data 26 and complementary data 28.

It also includes a filtering module 64 configured to remove at least part of the complementary data 28, a re-encapsulation module 66 of image data 26 according to a second video transmission protocol, advantageously distinct from the first video transmission protocol, to generate the output video stream 22, a compliance control module 67 of the output video stream 22 according to the specifications of the second video transmission protocol, and a transmission module 68 of the output video stream 22 to the second domain 16, particularly to the display management set 38 of the display device 36.

The control unit 56 of the control plane includes a memory 80 storing the spatial and temporal input parameterization including a frame definition, synchronization including a clock frequency and image refresh rate, and a predefined resolution desired for the input video data stream 24.

The control unit 56 of the control plane comprises a module 82 for providing the predetermined values of the spatial and temporal input parameterization to the input/output 52A, 52B and a receiving module 84 of the input video data stream 24 to verify its compliance with the input control plane 30.

The control unit 56 of the control plane advantageously includes an addition module 86 of a compliance indicator to the output video stream 22.

The memory 80 is preferably a non-volatile memory, for example, EPROM containing predetermined values of the desired spatial and temporal parameters of image data 26. These values include predetermined values of frame definition, synchronization, and/or resolution controlled for image data 26. They form the control plane parameters for the input video stream 20 imposed by the security system 18.

A method for securing a video link between a first domain 12, 14 with lower security requirements and a second domain 16 with higher security requirements will now be described.

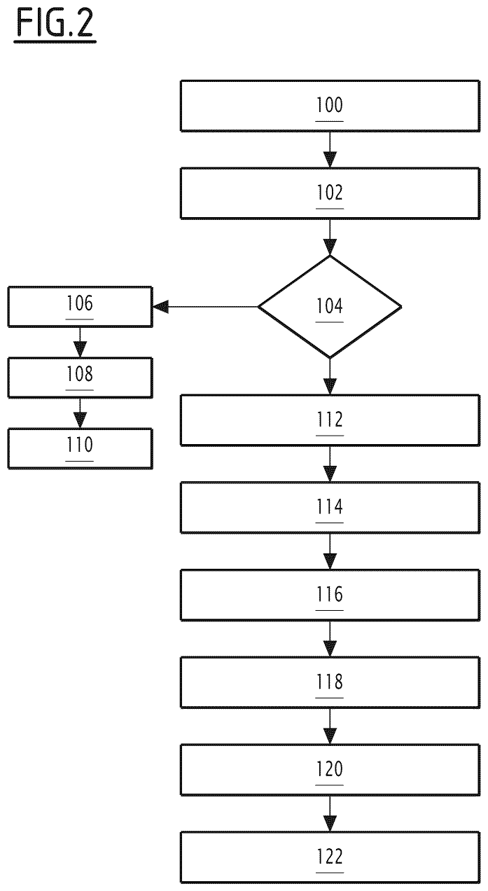

Referring to FIG. 2, at step 100, a system 42, 44 of the first domain 12, 14 is connected to the receiving input 50A, 50B.

The system 42, 44 generates the input video data stream 24, which is transmitted to the security system 18 using the first transmission protocol.

At step 102, the input video data stream 24 is received in the receiving and compliance test module 60.

In this module 60, at step 104, the input video data stream 24 is tested to verify its compliance with the first video transmission protocol, with respect to the protocol specifications stored, for example, in a table of the processing unit 54.

As described below (see steps 132 and following), a compliance test of the input video data stream 24 with respect to the expected control plane parameters for the input video data stream 24 is also performed.

At step 106, if the input video data stream 24 is not compliant with the first video transmission protocol, the module 60 generates an alert, which, at step 108, is stored in a security log.

The input video data stream 24 not compliant with the first video transmission protocol is then eliminated at step 110, without transmission to the second domain 16.

The compliance test allows verification, in particular, of the size of the data transmitted by message, the presence of illegal characters, and/or the presence of random data in the input video data stream 24.

Steps 104 to 110 thus ensure security with respect to the sending of malformed data likely to disrupt the systems receiving them in the second domain 16.

In the case where the input video data stream 24 is compliant with the first video transmission protocol, it is transmitted to the de-encapsulation module 62.

At step 112, the module 62 de-encapsulates the input video data stream 24 to extract, on the one hand, image data 26 and, on the other hand, complementary data 28, in particular, metadata associated with frames and images and/or control plane data.

At step 114, the filtering module 64 eliminates at least partially, preferably totally, the complementary data 28, which are not transmitted to the second domain 16.

At step 116, the re-encapsulation module 66 receives the image data 26 from the filtering module 64 and re-encapsulates them according to a second transmission protocol, advantageously distinct from the first transmission protocol, to generate the output video stream 22.

At step 118, the control module 67 controls the compliance of the output video stream 22 with respect to the specifications of the second transmission protocol, which are stored, for example, in a table of the processing unit 54.

If the output video data stream 22 is not compliant with the second video transmission protocol, the control module 67 generates an alert, which is stored in the security log.

The output video data stream 22 not compliant with the second video transmission protocol is then eliminated, without transmission to the second domain 16.

At step 120, in the case where the output video stream 22 is compliant with respect to the specifications of the second transmission protocol, the transmission module 68 transmits the output video stream 22 to the second domain 16 via the transmission output 53.

At step 122, the output video stream 22 is, for example, received by the display generation set 38 of the display device 36. It is processed by the display generation set 38 to be displayed on at least one display area, particularly on at least one of the display areas 37A to 37D, or to produce a modified video stream using at least part of the output video stream 22 and display the modified video stream on at least one display area.

The protocol break carried out within the security system 18 prevents the transmission of malicious data via covert channels within the input video data stream 24 developed according to the first transmission protocol, since only the image data 26 are retained in the output data stream 22 generated according to the second transmission protocol.

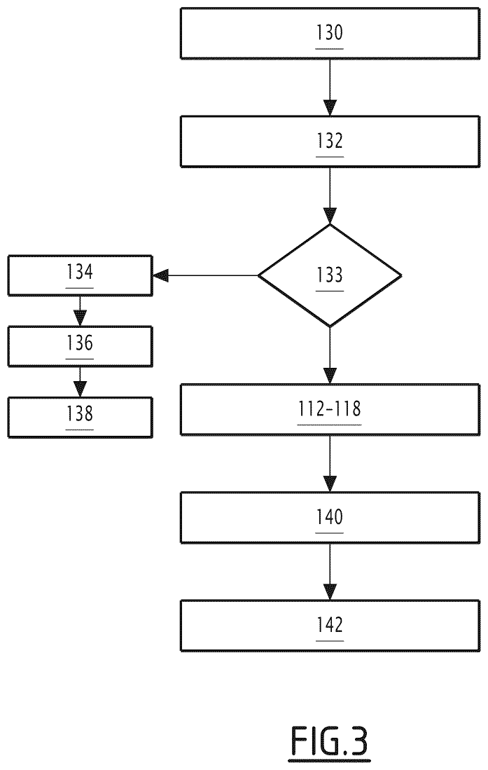

Referring to FIG. 3, at step 130, prior to the or each step 100, upon request from the system 42, 44 via the input control plane data stream 30, the predefined values of the spatial and temporal parameters intended to generate the input video data stream 24 are provided by the provision module 82, from the predefined values stored in the memory 80. The input control plane data stream 30 is, for example, generated according to a display data channel (DDC) protocol, notably DDC-I, or according to an Inter-Integrated Circuit (I2C) protocol.

The transmission of predefined values of spatial parameters (such as image resolution, for example) and temporal parameters (such as image refresh rate, for example) from predefined values contained in a memory 80 of the security system 18 prevents the control plane parameterization from being illicitly modified on the path to the second domain 16 by avoiding creating a covert control plane parameterization channel, since the parameterization is imposed by the values present in the memory 80.

Furthermore, at step 132, the receiving module 84 of the control plane data tests the compliance of the input video data stream 24 received by the module 60 with respect to the control plane parameterization, particularly with respect to the predefined input parameterization values contained in the memory 80.

For example, at step 133, the receiving module 84 compares the values of the spatial and temporal parameters of the input video data stream 24 and determines if they are equal to the predefined values of the spatial and temporal parameters contained in the memory.

If the values are not equal, the spatial and temporal input parameterization of the input video data stream 24 is non-compliant. At step 134, an alert is generated by the module 84 and is stored at step 136 in an alert log. At step 138, the module 84 then eliminates the input video data stream 24, which is not transmitted to the second domain 16.

This prevents the transmission of illegitimate commands in an uncontrolled data path.

Moreover, if the spatial and temporal input parameterization of the input video data stream 24 is deemed compliant, the output video stream 22 is generated as previously described in steps 112 to 118.

The spatial and temporal output parameterization of the output video stream 22 can also be imposed by predefined values contained in the memory 80.

The addition module 86 then optionally generates at step 140 a compliance indicator from the predefined values of the spatial and temporal parameters, for example, in the form of a cyclic redundancy check.

The compliance indicator is, for example, encapsulated with the input image data at step 116 by the re-encapsulation module 66 to be integrated into the second transmission protocol and transmitted to the second domain 16.

At step 142, during the de-encapsulation of the output video stream 22, a compliance control of the spatial and temporal output parameterization of the output video stream 22 can then be performed by the generation set 38.

Thus, the spatial and temporal output parameterization of the output video stream 22 is also controlled within the security system 18 and can be tested by the encapsulated compliance indicator.

The transmission of the video stream through the security system 18 is therefore particularly secure. This notably allows the use of video streams from less secure systems 42, 44 within a cockpit display device 36 without compromising the security of the aircraft.

This is achieved thanks to a particularly simple architecture, with a single component placed at the interface between the first domains 12, 14 with lower security requirements and the second domain 16 with higher security requirements.

In a variant, a unidirectional return link 200 is, for example, established between the second domain 16 and the first domain 12, 14 without passing through the security system 18, to ensure, notably, a user selection return on a display area of the output video stream 22, implemented using a selection and/or control system, such as a touchscreen, keyboard, or mouse.

This return link 200 is, for example, established in the form of a User Datagram Protocol (UDP) or by other digital data transmission protocols, such as an RS232 protocol, an RS422 protocol, an ARINC 429 protocol, or an ARINC 729 protocol.

What is claimed is:

1. A method of securing an aircraft video link linking a first domain with first security requirements to a second domain with second security requirements, the first security requirements being lower than the second security requirements, the method being carried out by a security system and including:
receiving, from the first domain, an input video data stream according to an input control plane including a spatial and temporal parameterization of the input video data stream;
transmitting to the second domain an output video stream obtained from the input video data stream, according to an output control plane including a spatial and temporal parameterization, the method comprising:
providing input control plane parameters imposed on the first domain, the imposed input control plane parameters including a defined spatial and temporal input parameterization defined by the security system.

2. The method according to claim 1, wherein the defined spatial and temporal input parameterization defined by the security system includes predetermined values of spatial and temporal parameters of the input video data stream.

3. The method according to claim 2, wherein the predetermined values are stored in a memory of the security system.

4. The method according to claim 3, wherein the predetermined values are stored in a read-only memory of the security system.

5. The method according to claim 1, wherein the spatial and temporal input parameterization includes a frame definition, a synchronization including a clock frequency and an image refresh rate and/or a resolution of the input video data stream.

6. The method according to claim 1, comprising, before transmitting to the second domain an output video stream, testing a conformity of a spatial and temporal parameterization of the input video data stream received from the first domain with respect to the defined spatial and temporal input parameterization provided to the first domain by the security system.

7. The method according to claim 6, wherein the testing comprises, in case of a non-conformity of the spatial and temporal parameterization of the input video data stream received from the first domain with respect to the defined spatial and temporal input parameterization provided to the first domain, generating an alert or/and storing the alert in an alert log.

8. The method according to claim 7, wherein the testing comprises deleting the input video data stream after generating the alert and/or after storing the alert in the alert log, without transmitting an output video stream to the second domain.

9. The method according to claim 1, further comprising controlling a conformity of the output video stream with respect to the output control plane, before the transmitting to the second domain the output video stream.

10. The method according to claim 9, wherein the controlling of the conformity of the output video stream comprises, in case of a non-conformity of the output video stream, generating of a security alert and/or storing the alert in an alert log.

11. The method according to claim 10, wherein the controlling of the conformity of the output video stream comprises deleting the output video stream in case of a non-conformity of the output video stream after generating the alert and/or storing the alert in the alert log.

12. The method according to claim 1, wherein the transmitting to the second domain the output video stream is carried out according to an ARINC 818 protocol, a Digital Video Interface protocol, a Display Port protocol, a high-definition multimedia interface protocol, or a serial digital interface protocol.

13. The method according to claim 1, wherein the providing the input control plane parameters imposed on the first domain is carried out via an input control plane parameter stream using a dedicated transmission channel, distinct from a transmission channel of the input video data stream.

14. The method according to claim 1, wherein the second domain is an aircraft control domain including at least one avionics.

15. The method according to claim 1, wherein the first domain is a passenger service domain configured to include at least one passenger service system, and/or is an operator service domain configured to include at least one operator service system.

16. The method according to claim 1, wherein the input video data stream is received using a first video transmission protocol encapsulating image data and complementary data, the method comprising:
de-encapsulating the input video data stream to extract image data and filtering of at least part of the complementary data;
re-encapsulating image data using a second video transmission protocol to generate an output video stream; and
transmitting to the second domain the output video stream using the second transmission protocol.

17. A security system configured to secure an aircraft video link linking a first domain with first security requirements to a second domain with second security requirements, the first security requirements being lower than the second security requirements, the security system being configured to:
receive, from the first domain, an input video data stream according to an input control plane including a spatial and temporal parameterization of the input video data stream;
transmit to the second domain an output video stream obtained from the input video data stream, according to an output control plane including a spatial and temporal parameterization; and
provide input control plane parameters imposed on the first domain, the imposed input control plane parameters including a defined spatial and temporal input parameterization defined by the security system.

18. The security system according to claim 17, comprising a programmable logic component or a dedicated logic circuit being configured to:
receive, from the first domain, the input video data stream according to the input control plane including the spatial and temporal parameterization of the input video data stream;
transmit to the second domain the output video stream obtained from the input video data stream, according to the output control plane including the spatial and temporal parameterization; and
provide the input control plane parameters imposed on the first domain, the imposed input control plane parameters including the spatial and temporal input parameterization defined by the security system, the security system including a memory storing predetermined values of the spatial and temporal input parameters of the input video data stream.

19. An aircraft comprising:
a first domain with first security requirements comprising an input video data stream generator configured to generate at least one input video data stream according to an input control plane including spatial and temporal parameterization of the input video data stream;
the security system according to claim 18, configured to generate an output video stream according to an output control plane including spatial and temporal parameterization, from the input video data stream; and
a second domain with second security requirements comprising at least one processor and/or display to process or/and display the output video stream, the first security requirements being lower than the second security requirements, the processor and/or display being connected to the security system.
